(19) United States
(12) Patent Application Publication
(10) Pub. No.: US 2006/0213702 A1
(43) Pub. Date: Sep. 28, 2006

(54) Power source for a self-propelled vehicle comprising a subsidiary engine for maintenance power needs and a main engine purely for propulsion

(76) Inventor: Ricardo Lim Roco, Alameda, CA (US)

Correspondence Address: RICARDO LIM ROCO, 557 Buena Vista Avenue, Alameda, CA, 94501, US

(21) Appl. No.: 11/089,747

(22) Filed: Mar. 25, 2005

(51) Int. Cl. B60K 8/00

(52) U.S. Cl. 180/54.1

(57) ABSTRACT

An improved power source for a self-propelled vehicle comprising a main engine (1) whose power is used purely for propulsion, a small electrically started subsidiary engine (2) that powers all the power consuming devices for the maintenance of the vehicle and for the running maintenance of the main engine (1), and means for connecting to and deriving the power from the subsidiary engine (2) to the power consuming devices of the vehicle and to the power consuming devices for the running maintenance of the main engine (1) such that all the power consuming devices for the maintenance of the vehicle and the power consuming devices for the running maintenance of the main engine (1) are connected to and are driven by the subsidiary engine (2).

### BACKGROUND

1. Field of Invention

This invention relates to the power source of self-propelled vehicles specifically to a power source wherein substantially all the unattenuated and unhampered power output of the engine of the self-propelled vehicle is used purely and only for moving and propelling the self-propelled vehicle.

2. Description of Prior Art

The power source of current self-propelled vehicles supply the self-propelled vehicle with power for moving or propulsion with power, that is the remaining power after the devices and accessories that need power for the maintenance of the self-propelled vehicle and for the maintenance of the main engine are supplied with power. Currently, the propulsive engine of the self-propelled vehicle supplies power to drive and power the self-propelled vehicle's electric generator or alternator, the air conditioner compressor, the oil pump, the power steering pump, and the water pump for the maintenance of the propulsive engine of the self-propelled vehicle. Currently, after all the devices needing power for the maintenance of the self-propelled vehicle and for the maintenance of the main propulsive engine of the self-propelled vehicle are provided power by the main propulsive engine of the self-propelled vehicle, the power that is left behind or the remaining power is then available for and used for the propulsion and moving of the self-propelled vehicle. Currently, the power and energy available and used for propelling and moving the self-propelled vehicle has already been attenuated and reduced and hampered substantially by the devices and accessories and energy users needed to maintain the self-propelled vehicle and the devices and accessories needed to maintain the main propulsive engine of the self-propelled vehicle, such that the pleasurable and much needed controllability and responsiveness of the self-propelled vehicle is substantially dampened and reduced. This current method of tapping power to provide maintenance of the self-propelled vehicle and maintenance of the propulsive main engine of the self-propelled vehicle makes a substantial drag, attenuation and power reduction to the power remaining to move and propel the self-propelled vehicle.

### OBJECTS AND ADVANTAGES

Several objects and advantages of my present invention are:
(a) to provide a power source for a self-propelled vehicle which can supply and make available for propulsion of the self-propelled vehicle substantially all of the unattenuated and unhampered energy produced by the power source of the self-propelled vehicle;
(b) to provide a power source for a self-propelled vehicle which can give the operator of the self-propelled vehicle a substantially high degree of control over the forward and backward movement of the self-propelled vehicle;
(c) to provide a power source for a self-propelled vehicle in which the attenuation done to the power finally available for propulsion of the self-propelled vehicle is put to a minimum such that the operator of the self-propelled vehicle have under his control substantially all of the unattenuated and unreduced power produced by the propulsive engine of the self-propelled vehicle;
(d) to provide a power source for a self-propelled vehicle which will allow the said self-propelled vehicle to operate on a very low fuel consumption rate mode while simultaneously providing the occupant of the self-propelled vehicle normal climate control when the self-propelled vehicle is standing still in a heavily snowy or very cold environment;
(e) to provide a power source for a self-propelled vehicle which will allow the said self-propelled vehicle to operate in a very low fuel consumption rate mode while the self-propelled vehicle is standing still and the internal climate of the said self-propelled vehicle is being brought to a normal warm internal climate while the self-propelled vehicle is in a heavily snowy or very cold environment and the operator of the self-propelled vehicle is not yet willing to go inside the said self-propelled vehicle;
(f) to provide a power source for a self-propelled vehicle that will give a substantially new and more livelier and responsive vehicle operating experience that is different from the currently felt responsiveness of self-propelled vehicles;
(g) to provide a power source for a self-propelled vehicle in which the main power shaft of the main engine of the self-propelled vehicle provides power that is unattenuated, unhampered, unburdened, and highly responsive to the demand inputs of the operator even while simultaneously substantial power is being used in the said self-propelled vehicle to power the self-propelled vehicle's internal climate regulator, electrical and mechanical devices, oil pump, water pump, headlights, audio equipment, power steering pump, and other main engine maintenance devices;
(h) to provide a self-propelled vehicle whose response delay to the vehicle operator's demand input is reduced substantially resulting in a self-propelled vehicle that is very responsive, lively, and safe; and
(i) to provide a self-propelled vehicle wherein the devices that need and use power for the maintenance of the said self-propelled vehicle and for the maintenance of the main propulsive engine of the said self-propelled vehicle like the oil pump, water pump, electric alternator, power steering pump, air conditioner compressor, and air blowers are provided by an electrically started subsidiary engine mounted and installed in the said self-propelled vehicle such that substantially all the unattenuated and unburdened power produced by a main engine of the self-propelled vehicle is available for and used purely for the propulsion of the said self-propelled vehicle.

Further objects and advantages are that if the said self-propelled vehicle is stranded in a very cold and snowy environment, the main engine can be shut off and the small subsidiary engine can be allowed to continue running and operating in a very low fuel consumption rate mode and thus keep the internal climate inside the self-propelled vehicle warm and livable for a substantially extended period of time sufficient to allow rescuers to reach the self-propelled vehicle in a timely manner.

### DRAWING FIGURES

FIG. 1 shows an embodiment of the present invention as implemented, incorporated and used in the power source of a self-propelled vehicle. FIG. 2 is a schematic representation of the electrical system of the present invention.

### REFERENCE NUMBERALS IN DRAWINGS

1. main engine of self-propelled vehicle
2. subsidiary engine of self-propelled vehicle
3. electric starter motor of subsidiary engine (2)
4. oil pump of main engine (1)
5. crankcase of main engine (1)
6. alternator
7. alternator pulley
8. belt that connects pulley of alternator (6) to pulley of water pump (10)
9. water pump of main engine (1)
10. pulley of water pump (9)
11. belt that connects pulley of water pump (10) to pulley bank (17) of subsidiary engine (2) of self-propelled vehicle
12. crankshaft pulley of main engine (1)
13. cover of main engine's camshaft belt
14. belt that connects alternator's pulley (7) to pulley of oil pump (4)
15. pulley of oil pump (4)
16. belt that connects pulley of oil pump (15) to pulley of subsidiary engine (2)
17. pulley bank of subsidiary engine (2)
18. belt that connects pulley of power steering pump (19) to pulley bank (17) of subsidiary engine (2) of self-propelled vehicle
19. pulley of power steering pump of self-propelled vehicle
20. power steering pump of self-propelled vehicle
21. pulley of air conditioner compressor of self-propelled vehicle
22. belt that connects pulley of air conditioner compressor (23) to pulley bank (17) of self-propelled vehicle
23. An air conditioner compressor of self-propelled vehicle
31. An electric storage batter of self-propelled vehicle
33. An electric switch, that is part of the usual and common automotive ignition-starter key. 33 is one of the two or more banked switch that is turned ON when the said usual and common automotive ignition-starter key is moved to its first ON position. Electrical switch 33 is banked with electrical switch 59.
35. A mono-stable one shot circuit module #1.
36. An electrical relay switch, that the mono-stable one shot circuit module #1 (35) puts to the ON status for three seconds whenever 35 senses that electric switch 33 is put to the ON status.
38. Represent the electrical ignition circuit of subsidiary engine (2).
40. Electrical diode or electrical rectifier that allows to be charged the electrical storage battery (31) whenever the alternator (6) is driven or powered by the subsidiary engine (2).
41. A voltage regulator that regulates the voltage and current in the electrical system of the said self-propelled vehicle.
43. Represent the electrical devices of the said main engine (1) and the said self-propelled vehicle that needs and uses electrical energy produced by the subsidiary engine (2) through the alternator (6).
45. An electrical switch, that is part of the usual and common automotive ignition-starter key. 45 is one of the two or more banked switch that is turned ON for a few-seconds when the usual and common automotive ignition-starter key is moved to its further ON position or to its second tier ON position. Electrical switch 45 is automatically returned to the OFF status when the hand's pressure is removed from the said usual and common ignition-starter key.
47. An independent manually operated electrical switch in the control panel of the said self-propelled vehicle. The normal position and status of electrical switch (47) is in the ON status. To shut down the main engine while simultaneosly allowing the subsidiary engine(2) to continue in the running status, electrical switch (47) is put to the OFF position.
48. A transistor relay circuit module. The transistor relay circuit module (49) puts to the ON status the electrical ignition circuit of the main engine (1).
51. An electrical relay switch. Electrical relay switch 51 is controlled by single transistor relay circuit module(49).
53. Represent the electrical ignition circuit of the said main engine (1).
55. A mono-stable one shot circuit module #2. Mono-stable one shot circuit module #2 (55) puts to the ON status for three seconds the usual and common automotive electric starter motor of the said main engine (1).
57. An electrical relay switch that is controlled by the mono-stable one shot circuit module #2 (55).
59. An electrical switch that is an integral part of the usual and common automotive ignition-starter key. Electrical switch (59) is an electrical switch that is banked with electrical switch (33). Electrical switch (33) and (59) are controlled simultaneosly.
61. An electric starter motor circuit of the main engine (1). Electric starter motor circuit (61) is the usual and common automotive electric starter motor circuit.
63. An independent electric switch in the control panel of the said self-propelled vehicle. Electrical switch (63) when put to the ON status turns ON the electrical power from the electrical storage battery (31) to the mono-stable one shot circuit module #1 (35), the transistor relay circuit module (49), and the mono-stable one shot circuit module #2 (55). Before the said self-propelled vehicle is operated, electrical switch (63) is put to the ON status.

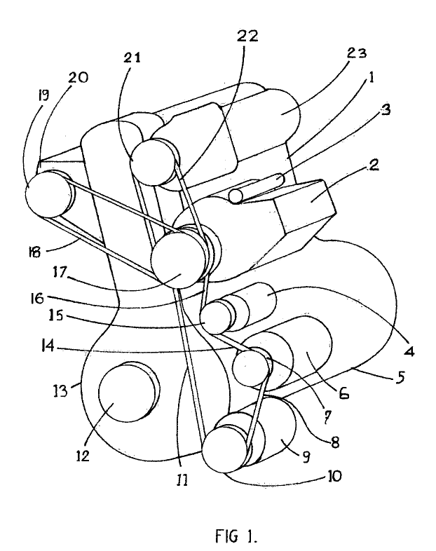

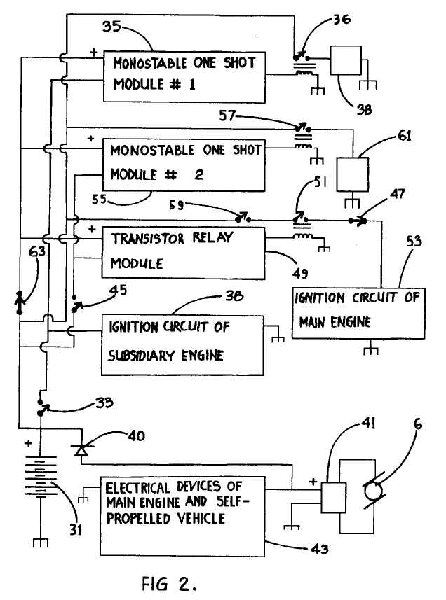

### DESCRIPTION—FIG. 1 AND FIG. 2

FIG. 1 shows an embodiment of the present invention as implemented, incorporated and used in the power source of a self-propelled vehicle. A main engine (1) is the usual and common transverse mounted four cylinder water cooled automotive engine of a front-engined car. Attached and mounted on the said main engine (1) is a subsidiary engine (2). The subsidiary engine (2) is a small one-cylinder air-cooled electrically started four-stroke engine. The subsidiary engine (2) is mounted and attached to main engine (1) on the mounting brackets where the usual and common car air conditioner compressor is mounted and attached in a usual and common four cylinder transverse mounted car engine. (17) is a three grooved pulley bank with three grooves that can accommodate three belts in individual pulley grooves. The mounting brackets and locking bolts of the subsidiary engine (2) are used to adjust the tightness of the belts that are attached to a pulley bank (17) of the subsidiary engine (2). A pulley bank (17) is a pulley module with three grooves of banked or firmly connected pulleys that accommodate and drive the belts that drive and power a power steering pump (20), an air conditioner compressor (23), an oil pump (4), an alternator (6), and a water pump (9). At the end of the power take-off shaft of the electrically started subsidiary engine (2) is attached and mounted a three grooved pulley bank (17). An alternator (6) is mounted and attached to main engine (1) in the common and usual manner the car alternator is mounted in a usual and common transverse mounted car engine. The alternator (6) is mounted and attached to the main engine (1) by the usual and common mounting, locking, and adjusting bolts. Mounted and attached at the end of the power-input shaft of the alternator (6) is an alternator pulley (7). The alternator (6) is driven and powered by the subsidiary engine (2) through the pulley bank (17), a belt (16), an oil pump pulley (15), a belt (14), the alternator pulley (7), a belt (8), a water pump pulley (10), and a belt (11). Mounted and attached on the main engine (1) is a water pump (9) of the main engine's (1) cooling system. A water pump (9) is the usual and common water pump of the usual and common four-cylinder car engine. The water pump (9) is mounted and attached on the main engine (1) in the usual and common manner a car engine's water pump is mounted in the usual and common car engine. The water pump (9) is mounted and attached to the main engine (1) by the usual and common mounting bolts. Mounted and attached at the end of the power-input shaft of the water pump (9) is a water pump pulley (10). The water pump (9) is driven and powered by the subsidiary engine (2) through the pulley bank (17), a belt (16), an oil pump pulley (15), a belt (14), an alternator pulley (7), a belt (8), a water pump pulley (10), and a belt (11). Mounted and attached to the main engine (1) is a power steering pump (20). The power steering pump (20) is used to provide power steering assist to the said self(c)propelled vehicle to which main engine (1) provides propulsive power. The power steering pump (20) is the usual and common power steering pump attached to the usual and common four-cylinder transverse mounted car engine. The power steering pump (20) is mounted and attached to the main engine (1) by the usual and common power steering mounting and locking bolts. Attached and mounted at the end of the power-input shaft of the power steering pump (20) is a power steering pump pulley (19). The power steering pump pulley (19) is connected to the pulley bank (17) by a belt (18). The power steering pump (20) is driven and powered by the subsidiary engine (2) through the pulley bank (17), a belt (18), and a power steering pump pulley (19). An air conditioner compressor (23) is mounted and attached to the main engine (1). The air conditioner compressor (23) is mounted and attached to the main engine (1) by the usual and common mounting brackets and mounting bolts that are used to mount and attach air conditioner compressors to the usual and common water cooled transverse mounted car engine. Additional mounting brackets are welded to the main engine (1) to accommodate the mounting brackets, mounting bolts and adjusting bolts of the air conditioner compressor (23). Attached and mounted at the end of the power-input shaft of the air conditioner compressor (23) is an air conditioner compressor pulley (21). The air conditioner compressor (23) is driven and powered by the subsidiary engine (2) through the pulley bank (17), a belt (22), and the air conditioner compressor pulley (21). Mounted and attached to the main engine (1) between the alternator (6) and the subsidiary engine (2) is an oil pump (4) for the pressurized lubrication system of the main engine (1). An oil pump (4) is mounted on the main engine (1) by mounting bolts. Additional mounting brackets are welded on main engine (1) to accommodate the mounting bolts of the oil pump (4). Mounted and attached at the end of the power-input shaft of the oil pump (4) is an oil pump pulley (15). The oil pump (4) is powered and driven by the subsidiary engine (2) through a pulley bank (17), a belt (16), an oil pump pulley (15), a belt (14), an alternator pulley (7), a belt (8), a water pump pulley (10) and a belt (11). An electric starter motor (3) is the electric starter motor of subsidiary engine (2). The electric starter motor (3) is an integral part of the subsidiary engine (2). A camshaft belt cover (13) is the cover of the camshaft belt of the main engine (1). The main engine (1) has a crankshaft pulley (12). In the present invention, the crankshaft pulley (12) is not driving or powering anything. The main engine (1) has crankcase (5). The subsidiary engine (2) is electrically started and put into operation by electric starter motor (3). When a subsidiary engine (2) is already put into operation and is in running status, the subsidiary engine (2) drives and powers a power steering pump (20), an air conditioner compressor (23), an oil pump (4), an alternator (6), and a water pump (9) by means of belts and pulleys. The subsidiary engine (2) is started independently from the main engine (1). The subsidiary engine (2) is started and put into running status before the main engine (1) may be started and put into running status by the usual and common car engine starter motor. When the subsidiary engine (2) is already in running status, the main engine (1) may be started, then shut down, then re-started again, then shut down again, all the while that subsidiary engine (2) is in the running status. The subsidiary engine (2) may not be shut down while main engine (1) is continuing in the running status by means of a system of cross switches, flip-flop circuit modules, and relays switches that is used and implemented as an integral part of the present invention.

FIG. 2 is a schematic representation of the basic electrical system of my present invention. (31) is an electric storage battery used by my invention. (33) is an electric switch that is part of the usual and common car ignition-starter switch of the usual and common self-propelled vehicle. (33) is one of the electric switches that is put to the ON status when the usual and common ignition-starter switch is moved or turned to its first ON position or to the first tier ON position. The usual and common car ignition-starter switch key when it is twisted to its first ON position turns ON the car's electrical ignition system, and when the said key is turned or twisted to the second tier ON position for a few moments, starts the usual car's engine. This is the ignition-starter key that this description is referring to. (35) is a mono-stable one shot module #1. (36) is an electric relay switch. (35) is a mono-stable one shot module #1 that turns ON electrically the electric relay switch (36) for three seconds when the mono-stable one shot module #1 (35) senses that the ignition-starter switch (33) has been put to the ON position. (38) represent the electric ignition circuit of the subsidiary engine (2). (3) is an electric starter motor circuit of the subsidiary engine (2). (36) is an electric relay switch that is controlled and put to the ON status by the mono-stable one shot circuit module #1 (35) when the usual and common ignition-starter key of the said self-propelled vehicle is moved to the first ON position which puts electrical switch (33) to the ON status. When the electric relay switch (36) is put to the ON status for three seconds by the mono-stable one shot circuit module #1 (35), the subsidiary engine electric starter motor (3) is operated for three seconds to start and put into running status the subsidiary engine (2). (40) is an electric rectifier that allows to be charged the electric storage battery (31) when the alternator (6) is driven and powered by the subsidiary engine (2). (41) is a voltage regulator module. The voltage regulator module (41) regulates the voltage and current in the electrical system of the said self-propelled vehicle and in the said main engine (1). (43) represents a set of electrical devices of the said self-propelled vehicle and of the said main engine (1). (45) is an electric switch that is a part of the usual and common automotive ignition-starter key of the self-propelled vehicle. The electrical switch (45) is an electric switch that is turned ON momentarily when the usual ignition-starter key of the said self-propelled vehicle is moved to the second ON position then returned to the first ON position by means of spring action when the pressure on the said key is released. (51) is an electrical relay switch that the transistor relay circuit module (49) puts to the ON status when the one transistor relay circuit (49) senses that the electrical switch (45) has been put to the ON status. (49) is a transistor relay module that through the electrical relay switch (51) puts to the ON status the electric ignition circuit of the main engine (51). When the common automotive ignition-starter key of the said self-propelled vehicle is put to the second ON position momentarily, the transistor relay circuit module (49) senses (45) has been closed momentarily, so that it closes the electric relay switch (51), which in turn puts to the ON status the electrical ignition circuit of the main engine (53), provided the independent manually operated electrical switch (47) is in the ON status. (47) is an independent manually operated electrical switch in the control panel of the said self-propelled vehicle that is moved to the OFF position if the main engine (1) is to be shut down while subsidiary engine (2) will be allowed to continue to be in the running status. (53) is a representation of the electrical ignition circuit of the main engine (1). (55) is a mono-stable one shot module #2. (57) is an electric relay switch that is controlled by mono-stable one-shot circuit module #2 (55). The mono-stable one shot circuit module #2 (55) puts to the ON status for three seconds the usual and common electric starter motor of the said main engine (1) through electric relay switch (57). (59) is an electrical switch that is an integral part of the usual and common automotive ignition-starter key of the said self-propelled vehicle. (59) is an electrical switch that is banked with the electrical switch (33). Electrical switch (33) and electrical switch (59) are controlled simultaneously by only one actuator which is the first ON position of the usual and common ignition-starter key of the said self-propelled vehicle. When the usual and common ignition-starter key of the said self-propelled vehicle is moved to the first ON position, electrical switch (33) and electrical switch (59) are both put to the ON status. When electrical switch (59) is put to the OFF status, the main engine (1) is shut down, and since electric switch (33) is banked with electric switch (59), the subsidiary engine (2) is also shut down. (47) is an independent manually operated electrical switch located in the control panel of the said self-propelled vehicle. Switch (47) is normally or usually in the ON status. When the electrical switch (47) is moved to the OFF status, the electrical ignition circuit of the main engine (1) is turned OFF. When the electrical switch (47) is moved to the OFF status, the main engine (1) is shut down while the subsidiary engine (2) is allowed to continue in the running status. To re-start the main engine (1), the electrical switch (47) is moved to the ON status and then the usual and common ignition-starter key of the said self-propelled vehicle is moved to the second ON position for a few seconds. (61) is the electric starter motor circuit of the main engine (1). (63) is an independent electrical switch located in the control panel of the said self-propelled vehicle that when put to the ON status connects the mono-stable one shot module #1 (35), the mono-stable one shot module #2 (55), and the transistor relay module (49) to the positive terminal of the storage battery of the said self-propelled vehicle. Before starting the power source of the said self-propelled vehicle, the electrical switch (63) is moved to the ON status. When the power source of the said self-propelled vehicle is to be completely shut off, the electrical switch (63) is put to the OFF status. In a diesel engine embodiment of the present invention, parts number (59), (51), (47), (53), (49), and (38) are not present and are not needed.

### OPERATION—FIG. 1, 2

FIG. 1 shows a power source of a self-propelled vehicle using my present invention. (1) is a main engine of a self-propelled vehicle. The main engine (1) is the usual, common, transverse mounted, four cylinder, water cooled, four-stroke car engine. Mounted and attached to the main engine (1) is a subsidiary engine (2). The subsidiary engine (2) of the present invention is a small, electrically started, four stroke, air-cooled, internal combustion engine. The subsidiary engine (2) is mounted and installed in the main engine in the same manner that the usual automotive air conditioner compressor is installed to the usual and common transverse mounted automotive engine. The subsidiary engine (2) is mounted and installed in the said main engine (1) by the usual and common mounting brackets and locking bolts by which the usual automotive air conditioner compressor is installed in the usual and common front mounted automotive engine. (17) is a three-grooved pulley bank (17) attached to the end of the power take off shaft of the subsidiary engine (2). The mounting brackets and locking bolts of the subsidiary engine (2) are used to adjust the tightness of the belts that are connected to the pulley bank (17). Shown in FIG. 1 and mounted in the usual manner they are mounted in the usual and common automotive engine are the usual and common automotive power steering pump (20), the air conditioner compressor (23), the alternator (6), and the water pump (9). Between the subsidiary engine (2) and the alternator (6) is mounted and attached the oil pump (4) of the pressurized lubrication system of the main engine (1). The oil pump (4) is attached and mounted on the main engine by mounting brackets welded into the cylinder block of the main engine (1). The oil pump (4) is attached and mounted into the main engine by means of mounting brackets and mounting bolts. (12) is the crankshaft pulley of the main engine (1) of the self-propelled vehicle where the present invention is utilized. The Crankshaft pulley (12) in the present invention is not connected to any belts. In the present invention, the crankshaft pulley (12) does not drive-and power anything. In the present invention, the crankshaft pulley is a pulley without any load. In the present invention, the power steering pump (20), the air conditioner compressor (23), the oil pump (4), the alternator (6), and the water pump (9) are connected to and are driven by the subsidiary engine (2) by means of pulleys and belts. In the present invention, the crankshaft pulley (12) is not connected to any power consuming device or load. In the present invention, when the subsidiary engine (2) is in the running status, it drives and powers the self(c)propelled vehicle's power steering pump (20), the air conditioner compressor (23), the alternator (6), the main engine's oil pump (4), and the water pump (9). In the present invention, the main engine's crankshaft pulley may be stationary and not moving even if the subsidiary engine (2), the power steering pump (20), the air conditioner compressor (23), the oil pump (4), the alternator (6), and the water pump (9) are running and working.

Operation, before the present invention is put into operation, the electrical switch (63) in the self-propelled vehicle's control panel is put to the ON position. This action powers up the mono-stable one shot circuit module #1 (35), the transistor relay circuit module (49), and the mono-stable one-shot circuit module #2 (55). Then, the self-controlled vehicle's usual and common ignition-starter key is moved to its first ON position. When the said ignition-starter key is moved to its first ON position, electrical switch (33) and electric switch (59) are switch into the ON status. When electrical switch (33) is put to the ON status, the electrical ignition circuit (38) of the subsidiary engine is put to the ON status and the mono-stable one shot circuit module #1 (35) senses that electrical switch (33) has been put to the ON status. When the mono-stable one shot circuit module # 1 (35) senses that electrical switch (33) has been put to the ON status, the mono-stable one shot circuit module # 1 (35) puts to the ON status electrical relay switch (36) for three seconds. When the electrical relay switch (36) is put to the ON status for three seconds, the electric starter motor circuit of the electric motor starter of the subsidiary engine (3) is powered up for three seconds to start and put to the running status the subsidiary engine (2). When the subsidiary engine (2) has been started and is in the running status, the alternator (6) charges the electrical storage batteries of the said self-propelled vehicle, electrical power is made available to electrical devices of the said self-propelled vehicle, electrical power is made available to the electrical switch gates of the transistor relay circuit module (49), the electrical starter motor circuit of the main engine (61), and the electrical relay switch (51). When the subsidiary engine (2) is already started and is in the running status, the subsidiary engine (2) drives and powers the power steering pump (20), the air conditioner compressor (23), the oil pump (4), the alternator (6), and the water pump (9). In the present invention, when the subsidiary engine (2) is in the running status, the main engine may not be running or may be in the running status. In the present invention, the power shaft of the subsidiary engine (2) and the power shaft of the main engine (1) are independent of each other. When the subsidiary engine (2) is in the running status and then the usual and common ignition-starter key of the said self-propelled vehicle is moved to the second ON position for a few seconds and then allowed to return back to the first ON position, the electrical switch (45) is put to the ON status for proportionately the same few seconds. The electrical switch (45) is part of the usual and common automotive ignition-starter key. The electrical switch (45) is one of the banked electrical switches that are actuated when the usual and common ignition-starter key of the said self-propelled vehicle is moved to the second ON position. When the electrical switch (45) is put to the ON status for a few seconds, the single transistor relay circuit module (49) and the mono-stable one shot circuit module # 2 (55) sense that electrical switch (45) has been put to the ON status for a few seconds. When the transistor relay circuit module (49) senses that electrical switch (45) has been put to the ON status for a few seconds, transistor relay circuit module (49) puts to the ON status or powers up the electrical ignition circuit of main engine (53) through electrical relay switch (51). When the mono-stable one shot circuit module # 2 (55) senses that electrical switch (45) has been put to the ON status for a few seconds, the mono-stable one shot circuit module # 2 (55) puts to the ON status for three seconds the electrical starter motor circuit of the main engine (61) through electrical relay switch (57). When the subsidiary engine (2) is in the running status, the main engine (1) may be started or may be allowed to remain in the shut down status depending on the operator of the said self-propelled vehicle. To start and put into the running status the main engine (1), the usual and common ignition-starter key of the said self-propelled vehicle is moved to the second ON position for a few seconds and then allowed to return to the first ON position by its own spring action. When the usual and common automotive ignition-starter key of the said self-propelled vehicle is moved to the second ON position, the electrical switch (45) is put to the ON status for proportionately the same few seconds. When the subsidiary engine (2) and the main engine (1) are in the running status and the operator of the said self-propelled vehicle has to shut down the main engine (1), the electrical switch (47) in the control panel of the said self-propelled vehicle is moved to the OFF position. When the electrical switch (47) is moved to the OFF position, the electrical power supplied to the electrical ignition circuit of the main engine (53) is shut off or cut off or put to the OFF status which shuts down the main engine. The main engine (1) may be shut down while the subsidiary engine (2) is allowed to continue in the running status. The subsidiary engine (2) is not allowed to be shut down while the main engine (1) is allowed to continue in the running status by means of the system of cross switches, cross relay switches and flip-flop circuit modules used and implemented by the present invention as shown in FIG. 2 and described in the description. If the subsidiary engine is to be shut down, the usual and common automotive ignition-starter key of the said self-propelled vehicle is moved out of the first ON position and moved back to the completely OFF position. When the usual and common automotive ignition-starter key of the said self-propelled vehicle is moved to the completely OFF position, electrical switch (33) and electrical switch (59) is put to the OFF status. When electrical switch (33) is put to the OFF status, the electrical power is cut off in the electrical ignition circuit of the subsidiary engine (38). When electrical switch (59) is put to the OFF status, the electrical power is cut off in the electrical ignition circuit of the main engine (53). When the usual and common automotive ignition-starter key of the said self-propelled vehicle is move to the completely OFF position, the subsidiary engine (2) and the main engine (1) are both shut down. When the subsidiary engine (2) and the main engine (1) are to be shut down, the electrical switch (63) in the control panel of the said self-propelled vehicle is moved to the OFF position. Moving the electrical switch (63) to the OFF position removes electrical power in the transistor relay circuit, and the mono-stable one-shot circuit modules.

FIG. 2 is a schematic representation of the basic electrical system of the present invention. (35) is a mono-stable one shot module # 1. (36) is an electric relay switch controlled by the mono-stable one-shot module # 1 (35). (3) is an electric starter motor of the subsidiary engine (2). (57) is an electric relay switch controlled by the mono-stable one-shot module # 2 (55). (61) is an electric starter motor circuit of the main engine (1). (61) is an electric circuit consisting of the solenoid and starter motor coils of the main engine (1). (55) is a mono-stable one-shot module # 2 (55). (59) is an electric switch that is a part of an automotive ignition-starter key module. (55) is one of the electric switch that is put to the ON status when the usual and common automotive ignition-starter key module is move to the first ON position. (55) is banked with electric switch (33). When the usual and common automotive ignition-starter key of the self-propelled vehicle using the present invention is moved to the first ON position, electric switch (55) and (33) are simultaneously put to the ON status. (51) is an electric relay switch that is controlled by the transistor relay switch (49). (49) is a transistor relay switch module that puts to the ON status electric relay switch (51) when transistor relay switch module (49) senses that the electric switch (45) has been put to the ON status for a few seconds. (53) is an electric ignition circuit of the main engine (1). (38) is an electric ignition circuit of the subsidiary engine (2). (33) is an electric switch that is a part of an automotive ignition-starter key module. (33) is put to the ON status when the automotive ignition-starter key module used by the self-propelled vehicle using the present invention is moved to the first ON position. The electric switch (33) is banked with electric switch (59). (63) is an electric switch installed in the control panel of the self-propelled vehicle using the present invention. The electric switch (63) is moved to the ON position if the power source of the self-propelled vehicle using the present invention is to be put to the running status. (31) is an electric storage batteries used by the self-propelled vehicle using the present invention. (40) is an electric rectifier device used by the present invention. (41) is a voltage regulator used by the present invention. The voltage regulator (41) regulates the voltage and electric current in the electrical circuit and electrical devices of the self(c)propelled vehicle using the present invention. (6) is the alternator of the main engine (1). (43) represent the electric power consuming devices in the self-propelled vehicle using the present invention and the electric power consuming devices in the main engine (1). In operation, when the power source of the self-propelled vehicle using the present invention is to be put into the running status, the electric switch (63) is moved to the ON position. Having electric switch (63) in the ON status powers up the mono-stable one-shot circuit module # 1 (35), the mono-stable one shot circuit module # 2 (55), and the transistor relay switch module (49). When the mono-stable one shot circuit module # 1 (35) is powered up or is connected to the positive terminal of the electric batteries (31) and electric switch (33) is put to the ON status, the mono-stable one shot circuit module # 1 (35) puts to the ON status for three seconds electric relay switch (36) which in turn runs for three seconds the electric starter motor of the subsidiary engine (3). Running the electric starter motor of the subsidiary engine for three seconds starts and puts to the running status the subsidiary engine (2). When the mono-stable one shot circuit module # 2 (55) is powered up and the electric switch (45) is put to the ON position for a few seconds, the mono-stable one shot circuit module # 2 (55) puts to the ON status the electric relay switch (57) for three seconds which in turn runs for three seconds the usual and common starter motor circuit of the main engine (61). (61) is an electric starter motor circuit of the main engine (1) comprising the solenoid and the starter motor coils of the starter motor of the main engine (1). When the transistor relay switch module (49) is powered up and then the electric switch (45) is put to the ON status for a few seconds, the transistor relay switch module (49) puts to the ON status the electric ignition circuit of the main engine (1) which would then allow the starting and putting to the running status the main engine (1). After electric switch (63) is put to the ON position, the usual and common automotive ignition-starter key module used by the self-propelled vehicle using the invention is moved to the first ON position or to the first tier ON position. When the ignition-starter key is moved to the first ON position, electric switch (33) and electric switch (59) are put to the ON status. When electric switch (33) is put to the ON status, the electric ignition circuit of the subsidiary engine (2) is connected to the positive terminal of the electric storage battery (31), and the mono-stable one shot circuit module # 1 (35) senses that electric switch (33) has been put to the ON status. When the mono-stable one shot module # 1 (35) senses that the electric switch (33) has been put to the ON status, the mono-stable one shot module # 1 puts to the ON status for three seconds the electric relay switch (36) which in turn puts to the ON status for three seconds or runs for three seconds the electric starter motor of the subsidiary engine (3). When the electric starter motor of the subsidiary engine (3) is put to the ON status for three seconds, the subsidiary engine (2) is started and put to the running status because the electric ignition circuit of the subsidiary engine (38) has been connected to the positive terminal of the electric storage battery (31) by electric switch (33). Moving the ignition-starter key to the first tier ON position starts the subsidiary engine (2). When the subdidiary engine (2) is already in the running status, the alternator (6), the power steering pump (20), the air conditioner compressor (23), the oil pump (4), and the water pump (9) are all in the running status. When the subsidiary engine is already in the running status, pressurized oil lubrication is already being supplied to the main engine, the alternator (6) is already charging the electric storage batteries (31), the internal climate of the self-propelled vehicle is already being regulated by the air conditioner compressor (23), the steering system already has power assist, and the cooling system of the main engine is already being put to the correct warm condition by the water pump (9). In a diesel engine embodiment of the present invention, parts number (59), (51), (47), (53), (49), and (38) are not present and are not needed.

### SUMMARY, RAMIFICATIONS, AND SCOPE

Accordingly, the present invention is a power source for a self-propelled vehicle wherein the power needs for the power using devices of the said self-propelled vehicle and the power needs for the power using devices for the maintenance of the main propulsive engine of the said self-propelled vehicle is provided by a small electrically started subsidiary engine (2) running at ideal and substantially constant speed and power such that substantially all the unattenuated and unburdened power output of the said self-propelled vehicle's main propulsive engine (1) is available for and used only for moving the said self-propelled vehicle. In addition, the present invention allows preliminarily putting only the subsidiary engine (2) into operation in a low fuel consumption rate mode when the said self-propelled vehicle is in a very cold and snowy environment so that the internal environment and the main propulsive engine (1) of the said self-propelled vehicle can be put into a warm and ideal status ready for occupancy and operation by the vehicle operator.

Although the description above contains many specificities, these should not be construed as limiting the scope of the invention but as merely providing illustrations of some of the presently preferred embodiment of this invention. For example, the subsidiary engine may provide the power for the power needs for the maintenance of two or more main engines and the power needs of the self-propelled vehicle.

Thus the scope of the invention should be determined by the appended claims and their legal equivalents, rather than by the examples given.

What is claimed is:

1. A method of having available for and using purely for the propulsion of a self-propelled vehicle substantially all of the unattenuated and unhampered power output of a main engine of the said self-propelled vehicle comprising mounting and installing in the said self-propelled vehicle a subsidiary engine that is connected to, drives and powers all the devices and accessories that need and use power to maintain the said self-propelled vehicle and the said main engine of the said self-propelled vehicle such that the said main engine of the said self-propelled vehicle is made free from substantially all power taps and free from the burden of driving and powering substantially any energy using devices and accessories for the maintenance of the said self-propelled vehicle and for the running maintenance of the said main engine whereby substantially all the unattenuated and unhampered power output of the said main engine of the said self-propelled vehicle is used purely and only for the propulsion and moving of the said self-propelled vehicle.

2. A power source for a self-propelled vehicle comprising a main engine and a subsidiary engine and means for deriving the accessory and maintenance power needs of the said self-propelled vehicle and the power needs for the running maintenance of the said main engine from the said subsidiary engine such that substantially all the unattenuated and unburdened power produced by the said main engine is available for and used purely and only for the propulsion and movement of the said self-propelled vehicle.

3. In combination, a power source for a self-propelled vehicle having a subsidiary engine and a main engine and means for having the said subsidiary engine drive and power substantially all the energy needing and energy using devices and accessories for the maintenance of the said self-propelled vehicle and for the running maintenance of the said main engine such that substantially all the unattenuated and unburdened power output of the said main engine is available for and used purely and only for the propulsion and movement of the said self-propelled vehicle.
